(19) United States
(12) Patent Application Publication
(10) Pub. No.: US 2009/0311159 A1
(43) Pub. Date: Dec. 17, 2009

(54) FUMED SILICA FOR USE AS AUXILIARY IN PHARMACEUTICAL AND COSMETIC COMPOSITIONS

(75) Inventor: Ann Gray, Hanau (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/376,128

(22) PCT Filed: Jul. 4, 2007
(86) PCT No.: PCT/EP07/56732

§ 371 Date: Feb. 3, 2009

(30) Foreign Application Priority Data
Aug. 22, 2006 (DE) 10 2006 039 273.6

(51) Int. Cl. C01B 33/12; B05D 3/10

(52) U.S. Cl. 423/335; 423/337; 427/337; 427/344

(57) ABSTRACT

Fumed silica for use as auxiliary substance in pharmaceutical and cosmetic compositions, which has—a BET surface area of 90 to 400 m²/g—a content of As, Cd, Cr, Pb, Sb and Se of less than 1 ppm for each elements and less than 5 ppm of Hg, all elements determined by Inductively Coupled Plasma—Atomic Emission Spectroscopy (ICP-AES) or Atomic Absorption Spectroscopy (AAS).

The invention provides fumed silica of high purity for use as an auxiliary in pharmaceutical and cosmetic compositions.

A drug normally comprises two groups of substances with different functions, namely active ingredients and auxiliary substances (excipients).

Active ingredients are characterized by their specific pharmacological action. They represent the active constituent of a drug. As such, they are identified quantitatively on both the packaging and the pack insert.

Auxiliary substances, on the other hand, have no pharmacological action. They are required so that a suitable form of administration, namely the drug, can be prepared for the active ingredient. The drug normally contains several auxiliary substances with different functions. For example, auxiliary substances act as fillers, binders, disintegrants, lubricants or release agents.

A large number of auxiliary substances can be utilized in the development of stable, easy-to-use and effective drugs comprising an active ingredient (or active ingredients) and auxiliary substances.

Highly disperse fumed silica, for example Aerosil®, is often used in pharmaceutical and cosmetic compositions. It can be used as a free flow agent, adsorbent and desiccant in solid product forms and as a suspension stabilizer and gelling agent in liquid and semi-solid product forms. It can also be used to increase the mechanical stability and the disintegration rate of tablets. It can also improve the distribution of the active ingredient.

There is however still the need to improve the properties of fumed silica for use as an auxiliary.

The object of the present invention is a fumed silica for use as auxiliary substance in pharmaceutical and cosmetic compositions, characterized in that said fumed silica has
a BET surface area of 90 to 400 m²/g
a content of As, Cd, Cr, Pb, Sb and Se of less than 1 ppm for each element and less than 5 ppm of Hg, all elements determined by Inductively Coupled Plasma—Atomic Emission Spectroscopy (ICP-AES) or Atomic Absorption Spectroscopy (AAS).

Preferably the content of As, Cd, Cr, Pb, Sb and Se is less than 0.1 ppm for each element and less than 1 ppm of Hg, all elements determined by ICP-AES.

Most preferably the content of As, Cd, Cr, Hg, Pb, Sb and Se is below the detection limit for ICP-AES, which is 0.05 ppm for As, Cd, Cr, Pb, Sb and Se and 0.4 ppm for Hg.

Preferably the content of Co, Cr, Cu, Mn, Nb, Ni, Ta, Ti and W is less than 1 ppm, most preferably less than 0.5 ppm, determined by ICP-AES.

Preferably the content of Fe and Al is less than 5 ppm, most preferably less than 1 ppm, determined by ICP-AES.

Preferably the content of Cl is less than 1000 ppm, most preferably less than 250 ppm.

The fumed silica of the present invention is manufactured by the hydrolysis of silicon tetrachloride in a hydrogen/oxygen flame according to the reaction: SiCl₄+2H₂+O₂→SiO₂+4HCl

This material can be densified in a subsequent step. This material can also be hdyrophobized in a subsequent step to yield a hydrophobic undensified material, which in turn can be densified. This material also can be granulated in a subsequent step to form granules.

The raw materials used are exclusively of inorganic origin and are very pure. Varying the process conditions results in products with different specific surface areas of 90 to 400 m²/g.

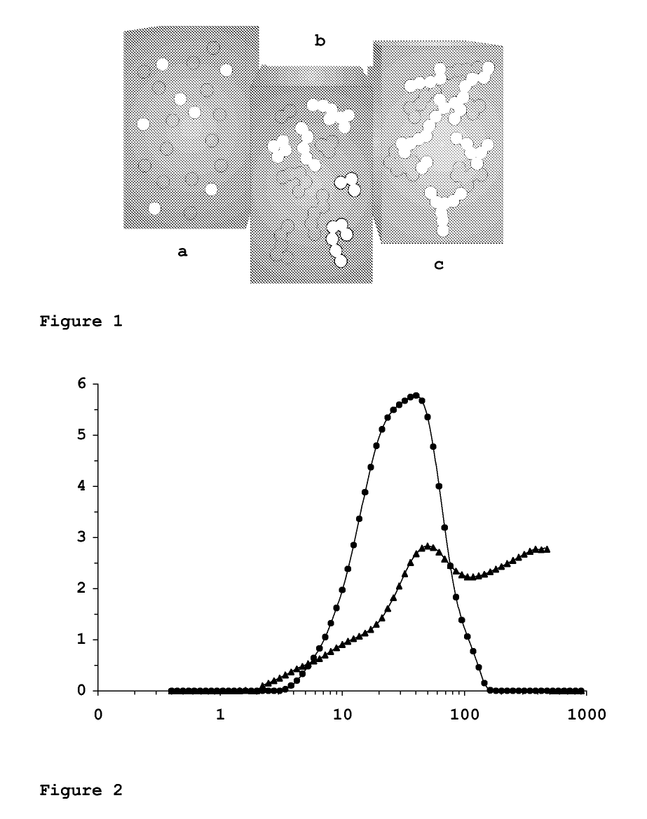

During the manufacture of the fumed silica particles, the vaporized silicon tetrachloride reacts with water (formed by hydrogen and oxygen gas) to form the individual particles, primary particles, of silica (FIG. 1a). However, these particles do not remain isolated, but collide, bond and sinter together, resulting in branched chain aggregates with a length of approx. 150 to 200 nanometers (FIG. 1b). The aggregates are the smallest actual units of fumed silica particles. Once the aggregates cool down to below the fusion point, additional collisions result in mechanical entanglement and hydrogen bonding of the chains, called agglomeration. The size of the agglomerates may be several hundred microns (FIG. 1c). Because agglomerates are only bound through weak forces, they can easily be broken down to aggregates during mixing or dispersion.

The material prepared in this way is hydrophilic in nature.

The fumed silica agglomerates are irregular in size and do not pack well. The considerable amount of void space between the agglomerates is responsible for the low tapped density of usual fumed silica and small agglomerates are responsible for the dustiness.

The BET surface area can preferably be 200±25 m²/g and particularly preferably 200±10 m²/g.

The BET surface area can preferably be 300±25 m²/g and particularly preferably 300±15 m²/g.

The BET surface area can preferably be 150±15 m²/g and particularly preferably 150±10 m²/g.

The BET surface area can preferably be 90±15 m²/g and particularly preferably 90±10 m²/g.

Another object of the invention is a process for the production of the silicon dioxide powder, which is characterised in that
at least one silicon halide is evaporated, the vapours are transferred by means of a carrier gas to a mixing chamber and a combustion gas and primary air, which can optionally be enriched with oxygen and/or be preheated, are transferred separately to the mixing chamber,
the mixture of the vapour of the silicon halide, combustion gas and primary air is ignited in a burner and the flame burns into a reaction chamber,
secondary air, which surrounds the flame, is introduced into the reaction chamber, the ratio of secondary air to primary air being in a range from 0.05 to 3, preferably 0.15 to 2,
the solid is then separated from gaseous substances and the solid is then steam-treated at 250° C. to 750° C.,

wherein
the silicon halide is selected from the group comprising SiCl₄, H₃SiCl, H₂SiCl₂, HSiCl₃, CH₃SiCl₃, (CH₃)₂SiCl₂, (CH₃)₃SiCl and (n-C₃H₇)SiCl₃
the silicon halide has a metal content of As, Cd, Cr, Pb, Sb and Se of less than 1 ppm for each element and less than 5 ppm of Hg, all elements determined by Inductively Coupled—Atomic Emission Spectroscopy (ICP-AES) or Atomic Absorption Spectroscopy (AAS)
the total amount of oxygen is at least sufficient for the complete combustion of the combustion gas and the silicon halide and
the amount of feed materials consisting of silicon halide, combustion gas, primary air and secondary air is chosen such that an adiabatic flame temperature T_{ad} of 1350 to 1900° C. is obtained, where
T_{ad}=the temperature of the feed materials+the sum of the reaction enthalpies of the partial reactions/heat capacity of the substances leaving the reaction chamber, comprising silicon dioxide, water, hydrogen chloride, carbon dioxide, oxygen, nitrogen, and optionally the carrier gas if it is not air or nitrogen,
taking the specific heat capacity of these substances at 1000° C. as a basis.

In special embodiment of the invention a mixture of silicon halides is used, SiCl₄ being the first silicon halide in a proportion of 60 to 95 wt. % relative to the mixture, and the second silicon halide is one chosen from the group comprising H₃SiCl, H₂SiCl₂, HSiCl₃, CH₃SiCl₃, (CH₃) ₂SiCl₂, (CH₃)₃SiCl, (n-C₃H₇)SiCl₃, in a proportion of 5 to 40 wt. %, relative to the mixture.

In addition it is preferred that SiCl₄, H₃SiCl, H₂SiCl₂, HSiCl₃, CH₃SiCl₃, (CH₃)₂SiCl₂, (CH₃)₃SiCl, (n-C₃H₇)SiCl₃ have a metal content of Co, Cr, Cu, Mn, Nb, Ni, Ta, Ti and W of less than 1 ppm as determined by ICP-AES.

It is also preferred that SiCl₄, H₃SiCl, H₂SiCl₂, HSiCl₃, CH₃SiCl₃, (CH₃)₂SiCl₂, (CH₃)₃SiCl, (n-C₃H₇)SiCl₃ have a metal content of Fe and Al of less than 5 ppm as determined by ICP-AES.

In a preferred embodiment the temperature of the feed materials is 90° C.±40° C.

In another preferred embodiment the discharge velocity of the reaction mixture from the mixing chamber to the reaction chamber is 10 to 80 m/s.

In another preferred embodiment the the adiabatic flame temperature T_{ad} is 1570 to 1630° C.

In another preferred embodiment the the adiabatic flame temperature T_{ad} is 1390 to 1450° C.

In another preferred embodiment the the adiabatic flame temperature T_{ad} is is 1670 to 1730° C.

In another preferred embodiment the the adiabatic flame temperature T_{ad} is is 1800 to 1880° C.

In further embodiment of the invention the fumed silica is a densified fumed silica having a tamped density of 80 to 250 g/l.

In preferred embodiment of the invention the fumed silica have a BET surface area of 200±25 m²/g and a tamped density of 120±20 g/l.

The densified fumed silics is manufactured by a densification technology, in which air is removed from between the agglomerates at the same time they are gently packed together. The result is larger, more stable agglomerates that produce considerably less fine dust (particles <10-20 μm in size) than undensified fumed silica particles. FIG. 2 shows the dry powder particle size distribution of agglomerates of an undensified fumed silica of 200 m²/g BET surface area () and a densified material of the same BET surface area and a tamped density of 120 g/l (▴), as they are taken directly from the bag. Values were measured using a laser diffraction method (Coulter, dry powder module). The densified material contains proportionally more larger agglomerates (>100 μm) and significantly fewer smaller agglomerates (“dust” <20 μm). In FIG. 2 the x-axis stands for the particle diameter in micrometer (μm) and the y-axis stands for vol. %

The densification process is purely physical, the only difference between undensified and densified fumed silica is their tapped density (see Table 1).

TABLE 1
Physical characteristics of undensified and densified fumed silica

| | undensified | densified |
|---|---|---|
| BET surface area (m²/g) | 200 ± 25 | 200 ± 25 |
| Tapped density (g/l) | approx. 50 | approx. 120 |
| pH (4% dispersion) | 3.5-4.5 | 3.5-4.5 |
| Loss on drying (105° C., 2 h) | ≦1.5 | ≦1.5 |
| Loss on ignition (dried material, | ≦1.0 | ≦1.0 |
| 1000° C., 2 h) | | |
| SiO₂ content (% by weight) | ≧99.8 | ≧99.8 |

The densified fumed silica may have handling advantages over undensified types
less dust is produced when weighing and metering
the ventilation speed in the work area (and hence the product loss) can be reduced
post-use clean up effort is reduced
less warehouse space is required
there is less packaging to dispose of

To achieve the most efficient results in a formulation, the larger agglomerates of densified fumed silica may be broken down during mixing, something that is achieved using typical pharmaceutical mixing processes.

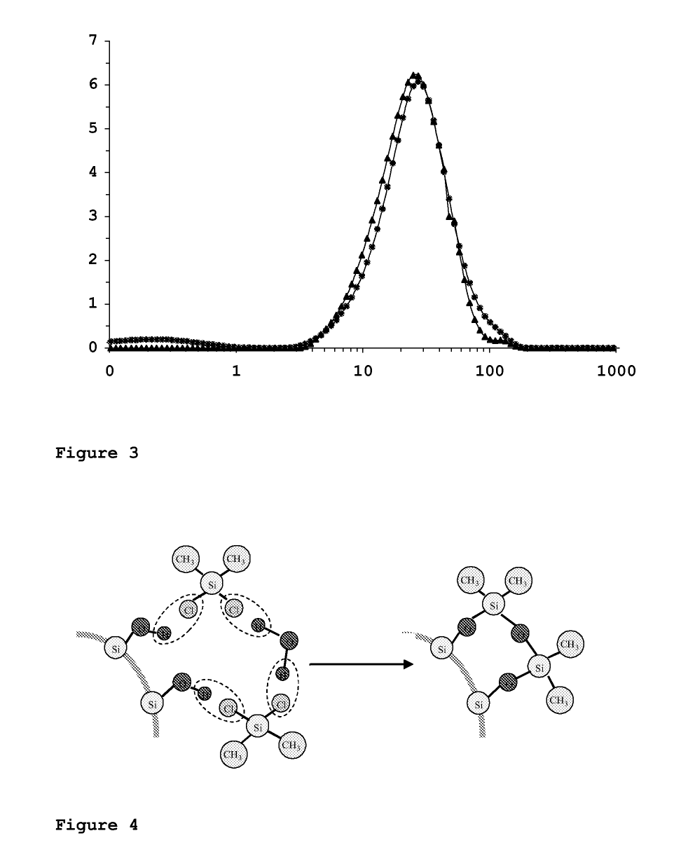

FIG. 3 shows the particle size distribution of undensified fumed silica having a BET surface area of 200 m²/g () and densified fumed silica of the same BET surface area (▴), both dispersed in sodium pyrophosphate buffer for 1 minute using ultrasound and measured by laser diffraction (Coulter). The graph shows the size distribution of the aggregates, since the agglomerates were broken down during the dispersion process. In FIG. 3 the x-axis stands for the particle diameter in micrometer (μm) and the y-axis stands for vol. %.

The aggregate sizes of densified and undensified material are practically identical.

A further object of the invention is a process for the preparation of the densified fumed silica which is comprised of a rotating a drum having a filter covering on its peripheral surface while the lower surface of the drum is in contact with a body of fumed silica, applying vacuum to the interior of the drum to draw a layer of said fumed silica into contact with the peripheral surface of the drum, the layer of said fumed silica being lifted from said body as the drum rotates, moving a flexible belt in an orbital path parallel with a substantial portion of the upper portion of the peripheral surface of said drum, densifying said fumed silica between said belt and said drum, and releasing the vacuum to separate the densified fumed silica from the drum.

In a further embodiment of the present invention the fumed silica is a surface treated hydrophobic fumed silica.

The hydrophobic fumed silica can preferably be silanized. Halosilanes, alkoxysilanes, silazanes and/or siloxanes can be employed for the silanization.

In particular, the following substances can be employed as halosilanes:
halo-organosilanes of the type X₃Si(CₙH₂ₙ₊₁) where X═Cl, Br and n=1-20,
halo-organosilanes of the type X₂(R′)Si(CₙH₂ₙ₊₁) where X═Cl, Br and R′=alkyl, n=1-20
halo-organosilanes of the type X(R′)₂Si(CₙH₂ₙ₊₁) where X═Cl, Br, R′=alkyl, n=1-20
halo-organosilanes of the type X₃Si(CH₂)ₘ—R′ where X═Cl, Br, m=0,1-20, R′=alkyl
halo-organosilanes of the type (R)X₂Si(CH₂)ₘ—R′ where X═Cl, Br, R=alkyl, m=0,1-20, R′=alkyl
halo-organosilanes of the type (R)₂X Si(CH₂)ₘ—R′ where X═Cl, Br, R=alkyl, m=0,1-20, R′=alkyl

In particular, the following substances can be employed as alkoxysilanes:
organosilanes of the type (RO)₃Si(CₙH₂ₙ₊₁) where R=alkyl, n=1-20
organosilanes of the type R′ₓ(RO)_{y}Si(CₙH₂ₙ₊₁) where R=alkyl, R′=alkyl, n=1-20, x+y=3, x=1,2, y=1,2
organosilanes of the type (RO)₃Si(CH₂)ₘ—R′ where R=alkyl, m=0,1-20, R′=alkyl
organosilanes of the type (R″)ₓ(RO)_{y}Si(CH₂)ₘ—R′ where R″=alkyl, x+y=2, x=1,2, y=1,2, R′=alkyl,

Trimethoxyoctylsilane [(CH₃O)₃—Si—C₈H₁₇] (for example DYNASYLAN® OCTMO, Degussa AG) can preferably be employed as the silanizing agent.

In particular, the following substances can be employed as silazanes:

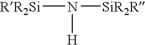

where R=alkyl, R′=alkyl, vinyl, as well as, for example, hexamethyldisilazane (for example DYNASYLAN® HMDS).

In particular, the following substances can be employed as polysiloxanes or silicone oils of the type:

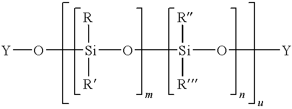

R=alkyl, H; R′=alkyl, H; R″=alkyl, H; R′′=alkyl, H; Y═CH₃, H, CₙH₂ₙ₊₁ where n=1-20; Y═Si(CH₃)₃, Si(CH₃)₂H, Si(CH₃)₂OH, Si(CH₃)₂(OCH₃), Si(CH₃)₂(CₙH₂ₙ₊₁) where n=1-20; m=0, 1, 2, 3, . . . ∞; n=0, 1, 2, 3, . . . ∞; u=0, 1, 2, 3, . . . ∞.

A further embodiment of the invention is a process for the preparation of the surface treated hydrophobic fumed silica, characterised in that the fumed silica according to the invention is sprayed, with intensive mixing, optionally first with water and/or dilute acid and then with one or more halosilanes, alkoxysilanes, silazanes and/or siloxanes, and mixing is optionally continued for a further 15 to 30 minutes, followed by tempering at a temperature of from 100 to 400° C. for a period of from 1 to 6 hours.

Another process for the preparation of the surface treated hydrophobic fumed silica according, characterised in that, with the exclusion of oxygen, the fumed silica according to the invention is mixed as homogeneously as possible with one or more halosilanes, alkoxysilanes, silazanes and/or siloxanes, the mixture, together with an inert gas, is heated to temperatures of from 200 to 800° C., preferably from 400 to 600° C., in a continuous flow process in a treatment chamber which is in the form of a vertical tubular furnace, the solid and gaseous reaction products are separated from one another, and then the solid products are optionally deacidified and dried.

The device for densifying the fumed silica is shown in U.S. Pat. No. 4,877,595.

FIG. 4 schematically shows the reaction of a fumed silica as obtained after flame with dichlorodimethyl silane at high temperature. As a result, two methyl groups are bound tightly to the surface by very stable siloxane bonds (see Table 2).

TABLE 2
Average bond dissociation energies (at
298 K) of selected chemical bonds.

| | Bond dissociation | Bond dissociation |
|---|---|---|
| | energy | energy |
| Bond type | kJ/mol | kcal/mol |
| C—C | approx. 345-350 | approx. 80-85 |
| Si—C | approx. 345-360 | approx. 80-85 |
| Si—O | approx. 452-460 | approx. 105-115 |

In a further embodiment of the present invention the fumed silica is in granular form.

Preferably the granular material based on fumed silica has a mean grain diameter of 10 to 120 μm and a BET surface of 40 to 400 m²/g (determination according to DIN 66 131 with nitrogen).

Preferably the silica granular material exhibits a pore volume of 0.5 to 2.5 ml/g, a pore size distribution in which less than 5% of the overall pore volume has a pore diameter of less than 5 nm, the remainder being mesopores and macropores, a pH value of 3.6 to 8.5, a tamped density of 220 to 700 g/l (determined as described in EP-A-725037).

Preferably the granular material may exhibit mesopores and macropores, the volume of the mesopores accounting for 10 to 80% of the total volume. The particle size distribution of the granular material is preferably 80 vol. % greater than 8 μm and 80 vol. % less than 96 μm. The proportion of pores smaller than 5 μm may in a preferred embodiment of the invention be at most 5% referred to the total pore volume.

The granular materials based on fumed silica may also be silanised. The carbon content of the granular material is then preferably 0.3 to 15.0 wt. %. The same halogenated silanes, alkoxysilanes, silazanes and/or siloxanes as mentionened above may be used for the silanisation.

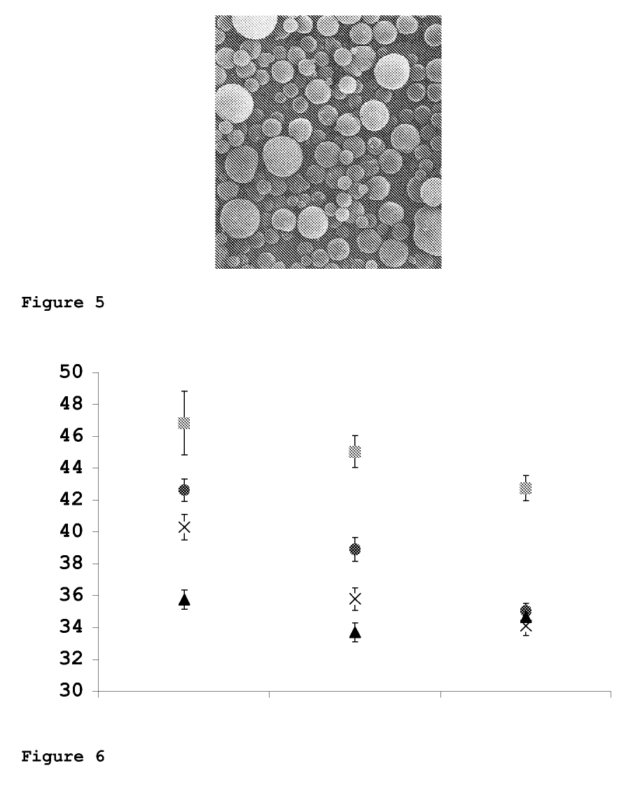

In a preferred embodiment the granular material has a pore volume of ca. 2.48 ml/g. Because of its spherical nature it is also much easier to handle when loaded than silica gel. FIG. 5 shows a scanning electron microscope image of the spherical granules. The average particle size is 30 μm.

The granules can be manufactured from fumed silica by a granulation process that is only physical, not chemical. It therefore has the same high degree of purity as fumed silica. This process is comprised of forming a dispersion consisting of water and fumed silica according to the invention, spray drying said dispersion, and optionally heating the granules obtained at a temperature of from 150° C. to 1,100° C. for a period of 1 to 8 hours.

The fumed silicas according to the invention can be used in pharmaceutical and cosmetic compositions as a glidant.

A number of different types of forces determine the mechanism of adhesion between solid particles: van der Waals forces, electrostatic forces, liquid bridges and entanglement. Typically the smaller the solid particles are, the more pronounced these effects are, and consequently the more cohesive the powder (i.e. poor powder flow properties). Fumed silica improves the flow of powders by acting to counteract these different mechanisms. Van der Waals forces and electrostatic attraction decrease with increasing distance between the particles. Small fumed silica aggregates adhere to the surface of the larger powder particles, increasing the distance, and reducing the attractive forces, between them. The hydrophilic nature of fumed silica obtained by flame hydrolysis allows it to attract and preferentially bind moisture, helping to eliminate liquid bridges between solid particles that hinder powder flow. In addition, aggregates also fill in voids and irregularities on the particle surface, decreasing entanglement between the larger particles.

The fumed silica according to the invention can act as a thickener for liquids.

When dispersed in a liquid, the silanol groups on the surface of fumed silica form hydrogen bonds with each other, either directly or indirectly through the liquid. The result is a temporary, three-dimensional network that is macroscopically visible as “thickening”. The more non-polar the medium (here the term “polarity” is used to mean the ability of the molecules of the medium to form hydrogen bonds) the more pronounced the effect. For example, the viscosity that can be achieved with a fumed silica having a BET surface area of 200 m²/g in liquid paraffin is much higher than in water. When shear forces are applied (stirring, shaking) the hydrogen-bond lattice is broken down and the viscosity decreases.

The fumed silica according to the invention can be used to manufacture tablets and filled capsules. Both of these solid dosage forms are manufactured from precursor powders that are filled into a fixed volume—either the empty capsule, or the tablet die. In order to maximize output on high speed machinery while fulfilling regulatory requirements for uniformity of unit weight (and therefore of dosage), it is essential that the precursor powder have excellent flow properties.

Just a small amount of fumed silica can improve the flow and packing characteristics of powders and granules, and thus the accuracy of metering. Undensified hydrophilic fumed silica and densified hydrophilic dumed silica also adsorb moisture readily to help keep powders and granules dry and free-flowing during storage.

In general, the more poorly the powder mixture flows, the greater the improvement that can be achieved using fumed silica as a glidant. However, each powder mixture is unique, so empirical testing is always required. It is preferred to start with a concentration of 0.5 wt % fumed silica (based on the total formulation) and adjusting this amount up or down to find the optimum concentration. Both too little and too much glidant can result in sub-optimal powder flow. Too little glidant, or enough glidant but too little mixing energy, can result in uneven coverage of the larger particles by the fumed silica. This, in turn, results in insufficient reduction of the attractive forces between the excipient particles and sub-optimal powder flow. Too much glidant, or excessive mixing energy, results in a nearly complete coverage of the larger particles with fumed silica. In this case the attractive forces between fumed silica particles increase significantly, with a concomitant worsening of powder flow. Overmixing can also cause poor powder flow by breaking down the excipient particles.

FIG. 6 compares the angle of repose of three common excipients as pure substances and also as binary mixtures with different fumed silica according to the invention. All the fumed silica types improved the powder flow over the pure excipient. Depending on the excipient, differences in the performance of different types were also observed. The flow of binary mixtures of microcrystalline cellulose (MCC; first column), pre-gelatinized starch (second column), and lactose monohydrate (third column) and 0.5% undensified fumed silica (; BET surface area 200 m²/g), 0.5% densified fumed silica (×; BET surface area 200 m²/g, tamped densitiy 120 g/l), 0.5% with dimethyl groups surface modified, undensified fumed silica (▴; BET surface area 110 m²/g) and no fumed silica ( [symbol] ) Mixing conditions: 10 minutes in a free-fall mixer at 60 rpm.

The mixing process also may have considerable influence on the flow characteristics of a powder. If mixed insufficiently, the agglomerates of fumed silica are not sufficiently broken down to smaller particles that can evenly coat the surface of the larger particles. In general, the energy required to sufficiently break down the agglomerates of different fumed oxide particles is as follows: hydrophobic, undensified<hydrophilic, undensified, <hydrophilic, densified.

Agglomerates of hydrophobic fumed silica are most easily broken up during mixing. This is because many of the surface hydroxyl groups have been methylated, and are no longer available to hydrogen bond (the forces that hold the agglomerates together).

Processing notes:
Determine the optimum fumed silica concentration, which is in general between 0.2 and 1.0% by weight empirically for the formulation.
Mix the entire quantity of fumed silica to be used with a small amount of one of the other excipient powders before screening. This will prevent re-agglomeration of the fumed silica particles. Preferably the fumed silica particles according to the invention should not be pre-mixed with a lubricant such as magnesium stearate.
Preferred mixers are free-fall (gravity) mixers or mechanical mixers that apply only small shear forces (e.g. plowshare mixers). The premix containing the fumed silica particles according to the invention should be added to the mixer first, followed by the other powdered constituents.
If one of the constituents is particularly critical—for example it is sticky and/or has poor flowability—it may be helpful to mix it first with the total amount of the fumed silica and then add the other ingredients.
Fumed silica granules can be added to the inner and/or outer phase.

The fumed silica according to the invention can be used to manufacture capsules.

Preferably the empty capsules are filled with the same volume of precursor powder mixture throughout the high-speed process in order to minimize capsule weight variation. It is therefore important to avoid non-uniform flow and the formation of powder bridges and cavities on the route between the storage container and the capsule. For this reason, fumed silica according to the invention is used to improve the flow of powders used to fill hard capsules.

Processing note:
Add fumed silica to the precursor powder mixture to improve its flow
Compared to traditional fumed silica, densified fumed silica may increase the bulk and/or tapped density of a powder mixture slightly, which could lead to an increase in capsule weight when the capsule volume remains constant.

The fumed silica according to the invention can be used to manufacture tablets.

Tablets must also meet strict requirements concerning uniformity of weight and active ingredient content. In this case it is the die that is filled volumetrically with powder. Directly compressible powders may contain fumed silica according to the invention as a glidant, to obtain the optimal powder flow necessary for high-speed tablet presses, increase throughput and reduce down-time of the press.

In addition to its role as glidant, the fumed silica according to the invention also provides additional benefits in many tablet formulations. Incompatibilities and sintering processes during compression can be avoided. In many formulations, hydrophilic undensified fumed silica, BET surface area of 200±25 m²/g, tapped density ca. 50 g/l and hydrophilic densified fumed silica, BET surface area of 200±25 m²/g, tapped density ca. 120 g/l can increase the rate of tablet disintegration by acting as a “wick” to draw water—for example from the digestive juices—into the interior of the tablet. The fumed silica according to the invention can also cause an increase in tablet hardness, depending on the other ingredients in the formulation and their compression characteristics (plastic deformation, fragmentation, etc).

Processing notes:
Add the fumed silica to the precursor powder mixture to improve its flow and tablet weight uniformity.
hydrophilic densified fumed silica, BET surface area of 200±25 m²/g, tapped density ca. 120 g/l may increase the bulk and/or tapped density of a powder mixture slightly, which could lead to an increase in tablet weight when the die volume remains constant.
If magnesium stearate is used, the fumed silica should be mixed with the other ingredients first, before mixing the magnesium stearate in briefly.
Hydrophobic, undensified fumed silica can increase disintegration times slightly, as well as decrease tablet hardness and friability, as compared with hydrophilic types. However, these effects are dependent on the other ingredients in the formulation.

The fumed silica according to the invention can be used to manufacture coated tablets.

The fumed silica can make tablet coating processes considerably less time-consuming and more economical. In conventional multilayer processes it is added to the build-up powder and/or to the pigment suspension. The build-up powder thus acquires good flow properties and can be distributed better on the cores. The tablet cores dry faster so that the individual coats can be applied at shorter time intervals. The mechanical strength—especially at the edges—is increased, and twinning is prevented. The adsorption capacity of the fumed silica also ensures that the cores are protected from moisture during coating.

The fumed silica also stabilizes pigment suspensions and contributes to the uniform texture of coated tablets.

If—as in most modern coating processes—no build-up powder is employed and only a highly concentrated coating suspension is used, the fumed silica can still be used to stabilize the pigment suspension and improve the texture of the coating.

Processing Notes:
Build-up powder: preferably hydrophilic undensified fumed silica, BET surface area of 200±25 m²/g, tapped density ca. 50 g/l and hydrophilic densified fumed silica, BET surface area of 200±25 m²/g, tapped density ca. 120 g/l at levels of 10 to 15 weight %
Pigment suspensions: preferably hydrophilic undensified fumed silica, BET surface area of 200±25 m²/g, at levels of 0.5 to 2.0 weight %.

The fumed silica according to the invention can be used as carrier for liquids and pastes.

Liquids and pasty ingredients are often difficult to blend with other powdered ingredients to be tabletted. The fumed silica in form of granules can be used to convert these to free-flowing and easily handled powders.

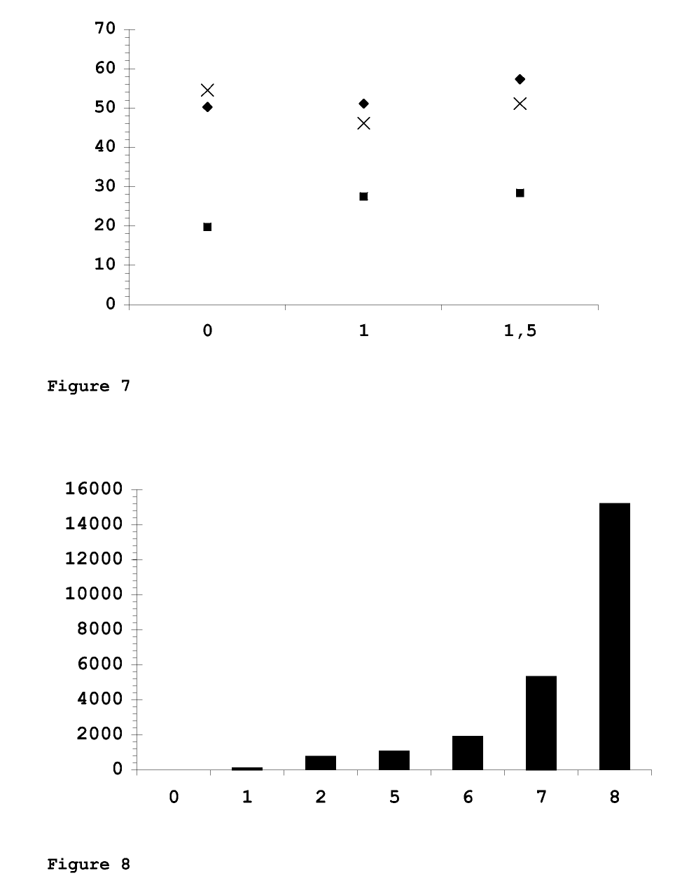

The granular material has little dust, flows freely even when loaded and is as easy to weigh and handle as other granulates. FIG. 7 shows the angle of repose of silica carriers loaded with various amounts of eucalyptus oil. X-axis stands for ratio of oil to silica (w/w), the y-axis stands for angle of repose in degrees. X=fumed silica powder, BET surface area 300 m²/g, as obtained by flame hydrolysis, ▴=silica gel , ▪=granules of fumed silica powder, BET surface area 300 m²/g, pore volume of ca. 2.48 mL/g.

Processing Notes:
Add 1 part of fumed silica granules to a mixing vessel. On a lab scale a three-necked flask fitted with an addition funnel is suitable. On a large scale, a tumble or plowshare mixer may be used.
Add 1 to 1.5 parts of liquid slowly, while mixing. Spraying is also possible.
Once the liquid is absorbed, the powder may be processed immediately or stored for later use.
Pasty ingredients may require a solvent. The solvent may be removed by vacuum or by drying. The granules are stable up to 300° C., although many active ingredients are sensitive to heat.

The fumed silica according to the invention can be used for gels, ointments, and salves.

Nonpolar liquids such as vegetable oils, liquid paraffin or isopropyl myristate can be converted to spreadable gels for example with a undensified, hydrophilic fumed silica having a BET surface area of 200±25 m²/g. If the refractive index of the oil is near to that of the fumed silica (1.46) then the gel will be transparent. These gels are distinguished by a high viscosity that has little dependence on temperature, and by a pronounced thixotropic behavior. They are therefore suitable for preparations that must meet strict requirements for storage and thermal stability. The more fumed silica used, the thicker the gel will be. Hydrophobic fumed silica can also be used to thicken pharmaceutical oils however it is less efficient than hydrophilic fumed silica, and the resulting viscosity will be lower. Hydrophobic fumed silica may be used to thicken the oil phase of a water-in-oil emulsion, stabilizing it and decreasing the need for organic emulsifiers. Both types also improve the distribution of insoluble ingredients in suspensions, gels and pastes.

FIG. 8 shows the relationship between the concentration of undensified, hydrophilic fumed silica having a BET surface area of 200 m²/g (wt. %; x-axis) and the viscosity of ethylhexyl palmitate (mpas; y-axis) using a dissolver, 5 cm blade, shear rate 15 m/sec for 7 minutes. Determination of viscosity using Brookfield 5 rpm after 24 h.

Processing Notes:
High shear mixers are required to disperse the fumed silica in oils. Rotor-stator or dissolver systems with a tip speed (circumference speed) of 15 m/sec or more are recommended.
Always calculate the maximum shear rate that can be achieved on large-scale equipment first and do not exceed this when working with laboratory machines.
The order of addition is not critical.
Tip speed is more important than dispersion time.
Begin with a concentration of 3 wt % fumed silica and adjust this up or down, depending on the viscosity desired.
Because the fumed silica according to the invention is not a source of microbial nutrition, preservatives can in some cases be reduced or eliminated, depending on the other ingredients in the formulation

The fumed silica according to the invention can be used for suppositories

The fumed silica, especially the undensified, hydrophilic one having a BET surface area of 200±25 m²/g, is important for the manufacture of suppositories. It ensures uniform distribution of active ingredients that are either insoluble or poorly-soluble in a suppository base (suspension suppositories). In addition, it increases the softening point of the suppository base without changing its melting point, an important property for improving stability in warm climates. The consistency and mechanical stability of the finished suppository are also improved. If active ingredients cause an unwanted reduction in the melting point of the suppository base (especially solution suppositories), this can be prevented by initially “triturating” the substance with the fumed silica according to the invention.

Processing Notes:
Concentrations of 0.5 to 2.0% by weight are recommended for suppositories
Powdered, liquid or pasty active ingredients should be ground or triturated with the fumed silica first and, where appropriate, sieved before they are introduced into the molten base.
Medium shear mixers should be used for semisolid products.
Add fumed silica first to ensure maximum mixing time.

The fumed silica according to the invention can be used for suspensions and aerosols.

Undensified hydrophilic fumed silica, preferably one having a BET surface area of 200±25 m²/g, according to the invention is an effective excipient for stabilizing dispersions of solids in liquids and preventing the formation of hard sediments in liquid suspensions and aerosol bulks (for topical, not inhalation, use). This is especially important for the pigment suspensions employed for tablet coating. The fumed silica may be used in redispersible powders as a wetting agent.

Processing Note:
Use undensified hydrophilic fumed silica having a BET surface area of 200±25 m²/g at a concentration of 0.5 to 3% by weight.

The fumed silica according to the invention may be used in combination with any arbitrary pharmaceutical active constituent. The following may be mentioned by way of example: α-proteinase inhibitor, abacavir, abciximab, acarbose, acetylsalicylic acid, acyclovir, adenosine, albuterol, aldesleukin, alendronate, alfuzosin, alosetrone, alprazolam, alteplase, ambroxol, amifostine, amiodarone, amisulprid, amlodipine, amoxicillin, amphetamine, amphotericin, ampicillin, amprenavir, anagrelide, anastrozole, ancrod, anti-haemophilia factor, aprotinin, atenolol, atorvastatin, atropine, azelastine, azithromycin, azulene, barnidipin, beclomethasone, benazepril, benserazide, beraprost, betamethasone, betaxolol, bezafibrate, bicalutamide, bisabolol, bisoprolol, botulinum toxin, brimonidine, bromazepam, bromocriptine, budesonide, bupivacaine, bupropion, buspirone, butorphanol, cabergoline, calcipotriene, calcitonin, calcitriol, camphor, candesartan, candesartan cilexetil, captopril, carbamazepine, carbidopa, carboplatin, carvedilol, cefaclor, cefadroxil, cefaxitin, cefazolin, cefdinir, cefepime, cefixime, cefmetazole, cefoperazone, cefotiam, cefoxopran, cefpodoxime, cefprozil, ceftazidime, ceftibuten, ceftriaxone, cefuroxime, celecoxib, celiprolol, cephalexin, cerivastatin, cetirizine, chloramphenicol, cilastatin, cilazapril, cimetidine, ciprofibrate, ciprofloxacin, cisapride, cisplatin, citalopram, clarithromycin, clavulanic acid, clindamycin, clomipramine, clonazepam, clonidine, clopidogrel, clotrimazole, clozapine, cromolyn, cyclophosphamide, cyclosporine, cyproterone, dalteparin, deferoxamine, desogestrel, dextroamphetamine, diazepam, diclofenac, didanosine, digitoxin, digoxin, dihydroergotamine, diltiazem, diphtheria protein, diphtheria toxoxide, divalproex, dobutamine, docetaxel, dolasetron, donepezil, dornase-α, dorzolamide, doxazosin, doxifluridin, doxorubicin, dydrogesterone, ecabet, efavirenz, enalapril, enoxaparin, eperisone, epinastin, epirubicin, eptifibatide, erythropoietin-α, erythropoietin-β, etanercept, ethinyl oestradiol, etodolac, etoposide, factor VIII, famciclovir, famotidine, faropeneme, felodipine, fenofibrate, fenoldopam, fentanyl, fexofenadin, filgrastim, finasteride, flomoxef, fluconazole, fludarabine, flunisolide, flunitrazepam, fluoxetine, flutamide, fluticasone, fluvastatin, fluvoxamine, follitropin-α, follitropin-β, formoterol, fosinopril, furosemide, gabapentin, gadodiamide, ganciclovir, gatifloxacin, gemcitabine, gestoden, glatiramer, glibenclamide, glimepiride, glipizide, glyburide, goserelin, granisetron, griseofulvin, hepatitis B antigen, hyaluronic acid, hycosin, hydrochlorothiazide, hydrocodone, hydrocortisone, hydromorphone, hydroxychloroquine, hylan G-F 20, ibuprofen, ifosfamide, imidapril, imiglucerase, imipenem, immunoglobulin, indinavir, indomethacin, infliximab, insulin, insulin human, insulin Lispro, insulin aspart, interferon β, interferon α, iodine 125, iodixanol, iohexol, iomeprol, iopromid, ioversol, ioxoprolen, ipratropium, ipriflavone, irbesartan, irinotecan, isosorbide, isotretinoin, isradipine, itraconazole, potassium chlorazepate, potassium chloride, ketorolac, ketotifen, whooping cough vaccine, coagulation factor IX, lamivudine, lamotrigine, lansoprazole, latanoprost, leflunomide, lenograstim, letrozole, leuprolide, levodopa, levofloxacin, levonorgestrel, levothyroxine, lidocaine, linezolid, lisinopril, lopamidol, loracarbef, loratadine, lorazepam, losartan, lovastatin, lysineacetylsalicylic acid, manidipin, mecobalamin, medroxyprogesterone, megestrol, meloxicam, menatetrenone, meningococcus vaccine, menotropine, meropenem, mesalamine, metaxalone, metformin, methylphenidate, methylprednisolone, metoprolol, midazolam, milrinone, minocycline, mirtazapine, misoprostol, mitoxantrone, moclobemid, modafinil, mometasone, montelukast, morniflumat, morphine, moxifloxacin, mycophenolate, nabumetone, nadroparin, naproxen, naratriptan, nefazodone, nelfinavir, nevirapine, niacin, nicardipine, nicergoline, nifedipine, nilutamide, nilvadipine, nimodipine, nitroglycerin, nizatidine, norethindrone, norfloxacin, octreotide, olanzapine, omeprazole, ondansetron, orlistate, oseltamivir, oestradiol, oestrogens, oxaliplatin, oxaprozin, oxolinic acid, oxybutynin, paclitaxel, palivizumab, pamidronate, pancrelipase, panipenem, pantoprazol, paracetamol, paroxetine, pentoxifylline, pergolide, phenytoin, pioglitazon, piperacillin, piroxicam, pramipexole, pravastatin, prazosin, probucol, progesterone, propafenone, propofol, propoxyphene, prostaglandin, quetiapine, quinapril, rabeprazol, raloxifene, ramipril, ranitidine, repaglinide, reserpine, ribavirin, riluzole, risperidone, ritonavir, rituximab, rivastigmin, rizatriptan, rofecoxib, ropinirol, rosiglitazone, salmeterol, saquinavir, sargramostim, serrapeptase, sertraline, sevelamer, sibutramin, sildenafil, simvastatin, somatropine, sotalol, spironolactone, stavudin, sulbactam, sulfaethidole, sulfamethoxazole, sulfasalazin, sulpirid, sumatriptan, tacrolimus, tamoxifen, tamsulosin, tazobactam, teicoplanin, temocapril, temozolomid, tenecteplase, tenoxicam, teprenon, terazosin, terbinafine, terbutaline, tetanus toxoid, tetrabenazine, tetrazepam, thymol, tiagabine, tibolon, ticarcillin, ticlopidine, timolol, tirofiban, tizanidine, tobramycin, tocopheryl nicotinate, tolterodine, topiramate, topotecan, torasemid, tramadol, trandolapril, trastuzumab, triamcinolone, triazolam, trimebutin, trimethoprim, troglitazone, tropisetrone, tulobuterol, unoproston, urofollitropine, valacyclovir, valproic acid, valsartan, vancomycin, venlafaxine, verapamil, verteporfin, vigabatrin, vinorelbine, vinpocetine, voglibose, warfarin, zafirlukast, zaleplon, zanamivir, zidovudine, zolmitriptan, zolpidem, zopiclone and their derivatives. Pharmaceutical active constituents are however also understood to include other substances such as vitamins, provitamins, essential fatty acids, extracts of plant and animal origin and oils of plant and animal origin.

The fumed silica according to the invention may also act as an auxiliary for cosmetic compositions. It can be used in cosmetic compositions of any consistency, e.g. in powders, liquids, foams, sprays, gels, creams, salves, pastes, sticks or tablets. Accordingly, the cosmetic compositions may be single- or multi-phase systems such as for example emulsions, suspensions or aerosols.

The cosmetic composition may be, for example, a soap; a synthetic “soapless” soap; a liquid washing or shower preparation; a bath additive; a make-up remover; an exfoliating preparation; a skin cream; a skin lotion; a face mask; a footcare product; a sun protection product; a skin tanning product; a de-pigmenting product; an insect repellent; a wet-shave product, such as a stick, cream, gel or foam; a pre-shave product; an after-shave care product; a depilatory product; a toothpaste; a hair shampoo; a hair care product, such as a hair mask, a rinse or a conditioner; a permanent wave product; a smoothing product, a hair styling product, such as a setting lotion, a hair spray, a hair lacquer, a hair gel or a hair wax; a hair colourant, such as a bleaching product, a hair colouring product, a tint or a colour fixer; a deodorant or an anti-perspirant, such as a stick, roll-on, lotion, powder or spray; a face make-up, such as a tinted day cream, a cream-to-powder foundation, a face powder, a cream foundation or a blusher; an eye make up, such as an eyeshadow, a mascara, a kohl pencil, an eyeliner or an eyebrow pencil; a lip care product; a decorative lip care product, such as a lipstick, a lip gloss or a lipliner pencil; a nail care product, such as a nail polish, a nail polish remover, a cuticle remover, a nail hardener or a nail care cream.

The present invention also provides a cosmetic composition, containing the previously-defined fumed silica and at least one constituent selected from absorbents, astringents, antimicrobial substances, antioxidants, anti-perspirants, anti-foam agents, anti-dandruff active ingredients, antistatic agents, binders, biological additives, bleaching agents, chelating agents, deodorants, emollients, emulsifiers, emulsion stabilisers, depilatory agents, colours, moisture-containing agents, film formers, perfumes, flavourings, hair colourants, preservatives, anti-corrosion agents, cosmetic oils, solvents, mouth care substances, oxidation agents, vegetable constituents, buffering agents, reducing agents, abrasives, detergents, propellents, opacity agents, UV filters and absorbers, denaturing agents, viscosity regulators and vitamins.

Depending on the cosmetic composition, in which the fumed silica is used, it may have various functions. It serves for example, to improve the skin feel of a product (ball bearing effect), adhesion to the skin and ease of application. Furthermore, the long-term stability of decorative cosmetics such as make-up, is improved by the adsorption of skin tallow and oil. Also in decorative cosmetics, it lessens the appearance of wrinkles by means of optimum, even distribution of light. In skin and hair cleansing products, the fumed silica can act as an abrasive. It is also suitable for concealing or absorbing characteristic or even unpleasant odours of cosmetic consituents, which could otherwise not be used. A further function is the fixing, or slow and controlled release, of highly volatile substances, e.g. essential oils, aromas and perfumes. In many cosmetic compositions they also act as fillers. Hydrophobic fumed silica is particularly suitable for the production of waterproof cosmetics.

However, the fumed silica according to the invention preferably act as carrier for cosmetic active ingredients and/or auxiliary substances. The present invention thus also relates to an adsorbate of the fumed silica granules according to the invention and at least one of these substances.

The expression “adsorbate”, as used here, encompasses not only the adsorption of a substance on the surface of the fumed silica, but also in the pores, and the “insertion” into the voids between the grains. “Adsorbate” can also mean that the fumed silica granules or fragments thereof, coats solid particles or liquid droplets of the substance. In the latter case, the attractive forces between the particles or droplets are reduced and, for example, the flow behaviour is improved or droplets are prevented from flowing together.

A cosmetic active ingredient according to this invention is deemed, as defined by Umbach (1995), to mean a substance in cosmetic preparations, which, under application conditions, has a physical, physical/chemical, chemical, biochemical and/or subject-related action, influencing inter alia the physiology and/or function of the skin or mucous membrane and their appendages, as well as the teeth, but excluding any significant effect on the organism. Examples of cosmetic active ingredients that can be adsorbed onto the fumed silica according to the invention are vitamins; moisture-containing agents such as polyalcohols, ceramides and compounds similar to ceramides; physical and chemical UV filters and astringents.

Of the cosmetic auxiliary substances, cosmetic oils, perfumes, flavourings or colours are preferably adsorbed onto the silicon dioxide granulate. The perfumes and flavourings may be either of natural, i.e. vegetable or animal, or synthetic, i.e. fully- and semi-synthetic, origin.

Examples of vegetable perfumes are essential oils and resinoids. Animal perfumes include e.g. musk, civet, castoreum and ambergris. The fully-synthetic perfumes include both those having a natural equivalent and purely invented compositions. Semi-synthetic perfumes are understood to be those isolated from natural perfumes and then chemically altered.

The colourants can also be natural or synthetic; they may be organic or inorganic compounds.

The quantity ratio of substance to fumed silica in the adsorbate may be selected at will, depending on the properties of the substance and the requirements of the end product. However, 0.001 to 200 g substance per 100 g fumed silica is preferably used, and in particular 10 to 150 g.

An example of a process for the production of the adsorbate according to the invention comprises:
(a) melting of the substance(es) to be adsorbed, selected from cosmetic active ingredients and auxiliary substances, or distribution, i.e. dissolution, suspension or emulsification of these substances in a solvent;
(b) mixing of the fumed silica with the mixture from step (a); and
(c) optionally, removal of the solvent.

Solvents also include mixtures of several different solvents. It is also understood that substances that are liquid at room temperature can be subjected to the mixing in step (b) without any prior processing, as in this case the “melting process” has already taken place. The mixing step (b) can take place either by adding the mixture from step (a) to the fumed silica, e.g. by spraying, or vice-versa. In both cases, addition can take place in one or several portions. The mixing time in step (b) depends primarily on the adsorption behaviour of the substance to be adsorbed on the silica surface. If a solvent is present, step (a) and step (b) are carried out at a temperature between the freezing and boiling point of the solvent. The optional excess solvent is removed in step (c), preferably at increased temperature and/or reduced pressure.

The removal of the solvent in step (c) can also be carried out either by spray- or fluid-bed drying, in which case the moulding process takes place simultaneously.

### EXAMPLES

Analytical: The fumed silica is analysed as to its metal content. The samples are dissolved in an acidic solution which comprises predominantly HF. The SiO₂ reacts with the HF, forming SiF₄ and water. The SiF₄ evaporates, leaving behind the metals which are to be determined. The individual samples are diluted with distilled water and analysed against an internal standard by inductively coupled plasma-atomic emission spectroscopy (ICP-AES) using a Perkin Elmer Optima 3000 DV.

### Example 1

### Fumed Silica having a BET Surface Area of Approx. 200 m²/g

70 kg/h of silicon tetrachloride and 35 kg/h of methyl trichlorosilane are evaporated and transferred to the mixing chamber of a burner by means of nitrogen. At the same time, 40 Nm³/h of hydrogen and 195 Nm³/h of primary air are introduced into the mixing chamber. The mixture displays a temperature of 90° C. It is ignited and burnt into a reaction chamber in a flame. In addition, 30 Nm³/h of secondary air, which surrounds the flame, are introduced into the reaction chamber.

The reaction gases and the silicon dioxide that is formed are drawn through a cooling system by application of a partial vacuum, cooling them to values between 100 and 160° C. The solid is separated from the waste gas stream in a filter or cyclone and then steam-treated at a temperature of 450° C.

Sum of reaction enthalpies from partial reactions: −196.1 KW; Heat capacity of products: 0,13 KJ/s·K; Adiabatic flame temperature: 1573° C.

The BET surface area is 204 m2/g. The metal contents are reproduced in Table 4.

### Example 2

### Fumed Silica having a BET Surface Area of approx. 300 m²/g

160 kg/h of silicon tetrachloride and 20 kg/h methyl trichloro silane are evaporated and transferred to the mixing chamber of a burner by means of nitrogen. At the same time, 58 Nm³/h of hydrogen and 190 Nm³/h of primary air are introduced into the mixing chamber. The mixture displays a temperature of 90° C. It is ignited and burnt into a reaction chamber in a flame. The discharge velocity from the burner is 33.6 m/s. In addition, 60 Nm³/h of secondary air, which surrounds the flame, are introduced into the reaction chamber. The ratio of secondary air to primary air is 0.28.

The reaction gases and the silicon dioxide that is formed are drawn through a cooling system by application of a partial vacuum, cooling them to values between 100 and 160° C. The solid is separated from the waste gas stream in a filter or cyclone and then steam-treated at a temperature of 560° C.

Sum of reaction enthalpies from partial reactions: −229.2 KW; Heat capacity of products: 0,17 KJ/s·K, Adiabatic flame temperature: 1427° C.

The BET surface area is 302 m²/g. The metal contents are shown in Table 5.

### Example 3

### Densified Fumed Silica

The fumed silica of Example 1 is densified according to the procedure given in U.S. Pat. No. 4,877,595. The tamped density is 120 g/l (according to DIN 55943).

### Example 4

### Hydrophobic Fumed Silica

The fumed silica of Example 1 is placed in a mixer and sprayed first with water (2 parts of water/100 parts of silica) and then with 10 parts hexamethyl disilazane/100 parts of silica) and 5 parts of methyl trimethoxysilane/100 parts of silica. The reaction mixture then undergoes a two-stage heat treatment (2 hours, 20° C.; 24 hours, 140° C.).

### Example 5

### Fumed Silica Granules

10 kg of fumed silica of Example 2 are dispersed in 100 kg deionised water using a rotor/stator dispersing device. The dispersion is spray dried. The product is deposited on a filter. The heat treatment of the spray-dried granular material is carried out in a muffle furnace at 380° C. The BET surface area of the granules is 280 m²/g. The grain size d₅₀ is 29 μm.

### Example 6

### Pharmaceutical Compositions using Densified Fumed Silica

The pulverulent ingredients are weighed out to an accuracy of 0.01 g in the order indicated and are mixed by hand. This mixture is passed through a sieve of mesh size 0.75 mm and then mixed in a glass flask for ten minutes using a free-fall (also known as a gravity or “turbula”) mixer. The compositions are then compressed into tablets and filled into capsules.

### Example 7

### Pharmaceutical Comopsition using Fumed Silica Granules

50.0 g of the fumed silica granules of example 5 is placed in a tall 600 ml capacity beaker and 50.0 g of vitamin E acetate (from BASF) is stirred in in portions using a spatula. The granules quickly absorbed the oily liquid, do not form any dust and do not produce an electrostatic charge. The total amount of the vitamin E acetate can be processed within ten minutes. The dry mixture is then screened through a sieve having a mesh width of 0.75 mm and allowed to stand overnight. The granules are then mixed with other excipients and filled into capsules, or tabletted.

TABLE 3
Metals*⁾ in SiCl₄ and MeSiCl₃, Ex. 1 and 2

| As | Cd | Cr | Hg | Pb | Sb | Se |
|---|---|---|---|---|---|---|
| <0.05 | <0.05 | <0.05 | <0.4 | <0.05 | <0.05 | <0.05 |

| Al | Co | Cu | Fe | Mn | Nb | Ni | Ta | Ti | W |
|---|---|---|---|---|---|---|---|---|---|
| 2 | <0.05 | <0.05 | 0.5 | <0.05 | <0.05 | <0.05 | <0.05 | 0.06 | <0.05 |

*⁾all values in Tables 3 to 8 in ppm

TABLE 4
Metals and chloride in fumed silica, Ex. 1

| As | Cd | Cl | Cr | Hg | Pb | Sb | Se |
|---|---|---|---|---|---|---|---|
| <0.05 | <0.05 | 12 | <0.05 | <0.4 | <0.05 | <0.05 | <0.05 |

| Al | Co | Cu | Fe | Mn | Nb | Ni | Ta | Ti | W |
|---|---|---|---|---|---|---|---|---|---|
| 3 | <0.05 | <0.05 | 0.8 | <0.05 | <0.05 | 0.06 | <0.05 | 0.1 | <0.05 |

TABLE 5
Metals and chloride in fumed silica, Ex. 2

| As | Cd | Cl | Cr | Hg | Pb | Sb | Se |
|---|---|---|---|---|---|---|---|
| <0.05 | <0.05 | <250 | <0.05 | <0.4 | <0.05 | <0.05 | <0.05 |

| Al | Co | Cu | Fe | Mn | Nb | Ni | Ta | Ti | W |
|---|---|---|---|---|---|---|---|---|---|
| 2.9 | <0.05 | <0.05 | 0.7 | <0.05 | <0.05 | 0.06 | <0.05 | 0.06 | <0.05 |

TABLE 6
Metals and chloride in densified fumed silica, Ex. 3

| As | Cd | Cl | Cr | Hg | Pb | Sb | Se |
|---|---|---|---|---|---|---|---|
| <0.05 | <0.05 | <250 | <0.05 | <0.4 | <0.05 | <0.05 | <0.05 |

| Al | Co | Cu | Fe | Mn | Nb | Ni | Ta | Ti | W |
|---|---|---|---|---|---|---|---|---|---|
| 3 | <0.05 | <0.05 | 0.8 | <0.05 | <0.05 | 0.06 | <0.05 | 0.06 | <0.05 |

TABLE 7
Metals and chloride in hydrophobic fumed silica, Ex. 4

| As | Cd | Cl | Cr | Hg | Pb | Sb | Se |
|---|---|---|---|---|---|---|---|
| <0.05 | <0.05 | <250 | <0.05 | <0.4 | <0.05 | <0.05 | <0.05 |

| Al | Co | Cu | Fe | Mn | Nb | Ni | Ta | Ti | W |
|---|---|---|---|---|---|---|---|---|---|
| 2.9 | <0.05 | <0.05 | 0.7 | <0.05 | <0.05 | 0.06 | <0.05 | 0.06 | <0.05 |

TABLE 8
Metals and chloride in fumed silica granules, Ex. 5

| As | Cd | Cl | Cr | Hg | Pb | Sb | Se |
|---|---|---|---|---|---|---|---|
| <0.05 | <0.05 | <250 | <0.05 | <0.4 | <0.05 | <0.05 | <0.05 |

| Al | Co | Cu | Fe | Mn | Nb | Ni | Ta | Ti | W |
|---|---|---|---|---|---|---|---|---|---|
| 2.9 | <0.05 | <0.05 | 0.5 | <0.05 | <0.05 | 0.06 | <0.05 | 0.06 | <0.05 |

TABLE 9
Pharmaceutical Compositions (in wt.-%)

| | Composition 1 | Composition 2 |
|---|---|---|
| Paracetamol | 83.3 | — |
| Acetylsalicylic acid | — | 83.3 |
| Powdered cellulose | 13.3 | 10.4 |
| Corn starch | 3.0 | 5.0 |
| Magnesium stearate | 0.1 | — |
| Stearic acid | — | 1.0 |
| Fumed silica, Ex. 3 | 0.3 | 0.3 |

1. A fumed silica powder having a BET surface area of 90 to 400 m²/g, and a content of As, Cd, Cr, Pb, Sb and Se each of less than 1 ppm and less than 5 ppm of Hg, all elements determined by Inductively Coupled Inductively Coupled Plasma—Atomic Emission Spectroscopy (ICP-AES) or Atomic Absorption Spectroscopy (AAS).

2. The fumed silica powder according to claim 1, wherein said fumed has a content of Co, Cr, Cu, Mn, Nb, Ni, Ta, Ti and W metals each in an amount of less than 1 ppm as determined by ICP-AES.

3. The fumed silica powder according to claim 1, wherein said fumed silica in addition has a content of Fe and Al metals each in an amount of less than 5 ppm as determined by ICP-AES.

4. The fumed silica powder according to claim 1, wherein said fumed silica in addition has a chloride content of less than 1000 ppm.

5. The fumed silica powder according to claim 1, wherein said the BET surface area is 200±25 m²/g.

6. The fumed silica powder according to claim 1, wherein the Bet surface area is 300±25 m²/g.

7. The fumed silica powder according to claim 1, wherein the BET surface area is 150±15 m²/g.

8. The fumed silica powder according to claim 1, wherein the BET surface area is 90±15 m²/g.

9. The fumed silica powder according to claim 1, wherein said fumed silica is surface treated hydrophobic fumed silica.

10. The fumed silica powder according to claim 1 wherein said fumed silica is a densified fumed silica having a tamped density of 80 to 250 g/l.

11. The fumed silica powder according to claim 1, wherein said fumed silica is in granular form.

12. A process for the production of the silicon dioxide powder according to claim 1, comprising:
evaporating a at least one silicon halide,
transferring the silicon halide vapours by means of a carrier gas to a mixing chamber and separately transferring a combustion gas and primary air, which is optionally be enriched with oxygen and/or preheated, to the mixing chamber;
igniting the mixture of the vapour of the silicon halide, combustion gas and primary air in a burner, wherein the flame of the burner burns into the a reaction chamber;
introducing secondary air, which surrounds the flame, into the reaction chamber, the ratio of secondary air to primary air being in a range from 0.05 to 3;
separating the solid from gaseous substances and the solid is then steam-treated at 250° C. to 750° C., wherein the silicon halide is selected from the group consisting of SiCl₄, H₃SiCl, H₂SiCl₂, HSiCl₃, CH₃SiCl₃, (CH₃)₂SiCl₂, (CH₃)₃SiCl and (n-C₃H₇)SiCl₃,
the silicon halide has a metal content of As, Cd, Cr, Pb, Sb and Se each of less than 1 ppm and less than 5 ppm of Hg, the contents of all elements determined by Inductively Coupled Plasma—Atomic Emission Spectroscopy (ICP-AES) or Atomic Absorption Spectroscopy (AAS)
the total amount of oxygen is at least sufficient for the complete combustion of the combustion gas and the silicon halide, and
the amount of feed materials consisting of silicon halide, combustion gas, primary air and secondary air is chosen such that an adiabatic flame temperature T_{ad} of 1350 to 1900° C. is obtained, where
T_{ad}=the temperature of the feed materials+the sum of the reaction enthalpies of the partial reactions/heat capacity of the substances leaving the reaction chamber, comprising silicon dioxide, water, hydrogen chloride, carbon dioxide, oxygen, nitrogen, and optionally the carrier gas if it is not air or nitrogen, taking the specific heat capacity of each of these substances at 1000° C. as a basis.

13. The process according to claim 12, wherein the silicon halide component a mixture of silicon halides, SiCl₄ being the first component in a proportion of 60 to 95 wt. % relative to the mixture, and the second component selected from the group consisting of H₃SiCl, H₂SiCl₂, HSiCl₃, CH₃SiCl₃, (CH₃)₂SiCl₂, (CH₃)₃SiCl, (n-C₃H₇)SiCl₃, in a proportion of 5 to 40 wt. %, relative to the mixture.

14. The process according to claim 12, wherein the temperature of the feed materials is 90° C.±40° C.

15. The process according to claim 12, wherein the discharge velocity of the reaction mixture from the mixing chamber to the reaction chamber is 10 to 80 m/s.

16. The process according to claim 12, wherein the silicon halides have a content of Ti, Mn, Cu, Cr, Ni, Co, W, Nb and Ta metals each of is less than 1 ppm as determined by ICP-AES.

17. The process according to claim 12, wherein the silicon halides have in addition a content of Fe and Al metals each of less than 5 ppm as determined by ICP-AES.

18. The process according to claim 12, wherein the adiabatic flame temperature T_{ad} is 1570 to 1630° C.

19. The process according to claim 12, wherein the adiabatic flame temperature T_{ad} is 1390 to 1450° C.

20. The process according to claim 12, wherein the adiabatic flame temperature T_{ad} is 1670 to 1730° C.

21. The process according to claim 12, wherein the adiabatic flame temperature T_{ad} is 1800 to 1880° C.

22. A process for the preparation of the surface treated hydrophobic fumed silica according to claim 9, comprising:
spraying the fumed silica powder according to claim 1, while being intensively mixed, optionally first with water and/or dilute acid and then with one or more halosilanes, alkoxysilanes, silazanes and/or siloxanes, optionally continuing mixing for an additional 15 to 30 minutes, followed by tempering at a temperature ranging from 100 to 400° C. for a period of from 1 to 6 hours.

23. The process for the preparation of the surface treated hydrophobic fumed silica according to claim 10, comprising:
with the exclusion of oxygen, homogeneously mixing the fumed silica according to claim 1 with one or more halosilanes, alkoxysilanes, silazanes and/or siloxanes, the mixture;
heating the mixture, together with an inert gas, to temperatures ranging from 200 to 800° C., in a continuous uniflow process in a treatment chamber which is in the form of a vertical tubular furnace, in which the solid and gaseous reaction products are separated from one another; and then
deacidifying and drying the solid products.

24. A process of preparing the densified fumed silica according to claim 10, comprising;
rotating a drum having a filter covering on its peripheral surface while the lower surface of the drum is in contact with a body of fumed silica powder according to claim 1,
applying vacuum to the interior of the drum to draw a layer of said fumed silica into contact with the peripheral surface of the drum, the layer of said fumed silica being lifted from said body as the drum rotates,
moving a flexible belt in an orbital path parallel with a substantial portion of the upper portion of the peripheral surface of said drum;
densifying said fumed silica between said belt and said drum, and releasing the vacuum to separate the densified fumed silica from the drum.

25. A process for the preparation of fumed silica in granular form according to claim 11, comprising:
forming a dispersion consisting of water and the fumed silica powder according to claim 1;
spray drying said dispersion; and optionally
heating the granules obtained at a temperature ranging from 150° C. to 1,100° C. for a period of 1 to 8 hours.
